(19) United States
(12) Patent Application Publication
(10) Pub. No.: US 2015/0296169 A1
(43) Pub. Date: Oct. 15, 2015

(54) Time-Space Storage Solution (TSSS)

(71) Applicant: Lamie Saif, Sollentuna (SE)

(72) Inventor: Lamie Saif, Sollentuna (SE)

(21) Appl. No.: 14/251,680

(22) Filed: Apr. 14, 2014

(51) Int. Cl. H04N 5/77; H04N 1/21; G11B 31/00; H04N 7/18

(52) U.S. Cl. CPC H04N 5/772; H04N 7/18; H04N 1/2112; G11B 31/006; H04N 2101/00

(57) ABSTRACT

TSSS CCTV-Data storage method uses Hardware and Software that exist in the market. TSSS method provide two CCTV data recorded copies (good and high quality) covering the whole retention period. both copies are with low level of information degradation by implementing (high number of fps, low compression level and prolonged pre/post time periods surrounding events recording).

Benefits of CCTV method:
1. A good quality and high quality recorded images in native format that are useable for visual inspection and forensic inspection purposes.
2. A good level of data availability by having good and high quality recorded copies
3. Easy to provide off-site high quality recording in native format useable for forensic purposes.
4. Low administration overhead.
5. Low total cost of ownership.

The right choice of Hardware and Software combined with the correct choice of configuration's parameters lead to a successful results in TSSS method.

### BACKGROUND

Now days the amount of needed storage space for CCTV-Cameras is very large in size that it challenges the skill of any network administrators in any place on earth. The reason for that is the fast developments of the hardware level in CCTV-Cameras industry and as a result the number of pixels in CCD/CMOS sensors has increased to multi-mega in values, that increase caused the increase of the size of the data produced for each image, this increase requires a wider transmission bandwidth and more storage space.

As an example a single CCTV-Camera may occupy about 1 TB of storage space per a single day recording, we may imagine how much storage space is needed for more number of cameras and/or for more number of days, if we want to store the information that is coming from 10 similar cameras and for 30 days the storage value shall jump to about 300 TB.

The solutions that has been used to minimize the need for large CCTV-Cameras data storage are divided into the following lines (data manipulation, low quality hardware and software).

Now these solutions in more details.

Minimizing the amount of recorded data through data manipulation using one or more of the following methods:
1. Compression using one of compression algorithm like (MPEG-4 and H.264) but this compression do not come free, the cost is low image quality (High compression leads to low image quality).
2. Reducing the number of captured frames per second (fps) and the cost is the possibility of losing a part of information or degrading the ability to analyse the movement in a correct way.
3. Events only recording, this can cause losing the information that is preceding the recorded event or the information that is succeeding the recorded event.
4. Choosing low resolution CCTV-Cameras or stepping down the resolution that the CCTV-Cameras can provide and the cost is low image quality.
5. Using less number of CCTV-Cameras and the cost is poor monitoring.
6. Reducing the retention time and the cost will be the inability of retrieving old recorded information.
7. Reducing the size of backup to cover the events only using small size storage like CD, DVD or USB memory cards, the cost will be a very poor archiving standard.

Reducing the total cost by:
1. Choosing low-end hardware, like the less reliable SATA hard disks instead of SAS hard disks.
2. Choosing low grade computers, which means lower reliability.
3. Choosing free or low cost operating systems, which might not support high end interfaces.
4. Choosing low end CCTV-Cameras, which means low reliability and low quality images.

Some companies solve the problem by using a complex form of storage process and this is done as follows:
1. Multi-tier stored data migration, when the time-line of the stored data in the first storage pool reaches a certain limits a data migration occur from the first storage pool to a second storage pool with longer time-line and when the time-line of the stored data in the second storage pool reaches a certain limits a data migration occur from the second storage pool to a third storage pool with longer time-line and at the end of this time-line the stored data will be written over.
2. Combining Hard disks and magnetic-tape to store and retrieve the stored data, this is done using tape library to insure the continuity of data storing and special software to to access the information that is stored in the magnetic tape using a very low quality and very low number of (fps) as image index.

The first solution does not reduce the volume of needed storage instead it divides the storage into separated pools with stepping down importance of the stored information.

The second solution depends on a very costly solution (tape library) and have two weak points, the first one is the (tape library) being a single point of failure that can take down the whole storage system, the other point is the image index can provide very low level image quality for visual inspection.

### BRIEF DESCRIPTION OF THE INVENTION

The idea of this utility invention (TSSS) is very simple but very unique, this solution applies only to IP connected CCTV cameras in an IP network.

The idea is built on capturing two copies of different quality CCTV video images of the same Field Of View (FOV) using (multi stream or dual lens dual sensor or camera pair) then store the captured images by two different storing methods.

The lower quality captured video images should give an accepted visual inspection level and shall be stored in the VMS (NVR) server first storage pool, this storage pool will be named (visual inspection storage).

The visual inspection storage pool capacity should be capable of storing the visual inspection images data stream for the whole defined retention period.

The higher captured video images should give an accepted forensic inspection level and shall be stored in the VMS (NVR) server second storage pool, this storage pool will be named (forensic inspection storage).

The forensic inspection storage pool capacity should be capable of storing the forensic inspection images data stream for one day only and at the end of each day the forensic inspection level stored data will be migrated to a new storage pool by using full backup/copy process.

The process of migrating what is named forensic inspection stored data directly to (magnetic-tape) will be named single tier method.

The process of migrating what is named forensic inspection stored data directly to a NAS server storage pool then to (magnetic-tape) will be named two tier method.

After each daily migration the source files shall be deleted and the forensic inspection storage pool shall be ready to store new incoming data.

The number of needed magnetic-tapes should be equal to the defined retention period number of days plus extra number of magnetic-tapes for off-line storage as needed.

### BRIEF DESCRIPTION OF THE DRAWINGS

FIG. 1.

Illustrates the traditional storage architect for collecting the data from (N) number of CCTV cameras connected to edge switches (1-1,2,3) then through links (1-4,5,6) to the core switch (1-15) then through links (1-16,17,18) into VMS (NVR) servers (1-9,10,11) with external hard disks enclosures (1-6,7,8).

FIG. 2.

Illustrates the TSSS single tier storage architect for collecting the data from (N) number of CCTV cameras connected to edge switches (2-1,2,3) then through links (2-4,5,6) to core switch (2-14) then through link (2-12) into VMS (NVR) server (2-7) with external hard disks enclosure (2-16) then from VMS (NVR) server (2-7) to the single tape drive (2-8).

FIG. 3.

Illustrates the TSSS two tier storage architect for collecting the data from (N) number of CCTV cameras connected to edge switches (3-1,2,3) then through links (3-4,5,6) to core switch (3-14) then through link (3-12) into VMS (NVR) server (3-7) with external hard disks enclosure (3-16) then migrating the data from VMS (NVR) server (3-7) through link (3-17) to NAS server (3-8), then from NAS server (3-9) to the single tape drive (3-10).

FIG. 4.

Illustrates the TSSS single tier storage architect for collecting the data from (2×N) number of CCTV cameras connected to edge switches (4-1,2,3,15,16,17) then through links (4-4,5,6,18,19,20) to core switch (4-14) then through link (4-12) into VMS (NVR) server (4-7) with external hard disks enclosures (4-22,23), then from VMS (NVR) server (4-7) to the two tape drives (4-8,9).

FIG. 5.

Illustrates the TSSS two tier storage architect for collecting the data from (2×N) number of CCTV cameras connected to edge switches (5-1,2,3,17,18,19) then through links (5-4,5,6,20,21,22) to core switch (5-14) then through links (5-13,15) to VMS (NVR) server (5-7) with external hard disks enclosures (5-26,28), then from VMS (NVR) server (5-7) to NAS server (5-8), then from NAS server (5-8) to two single tape drives (5-9,12).

FIG. 6.

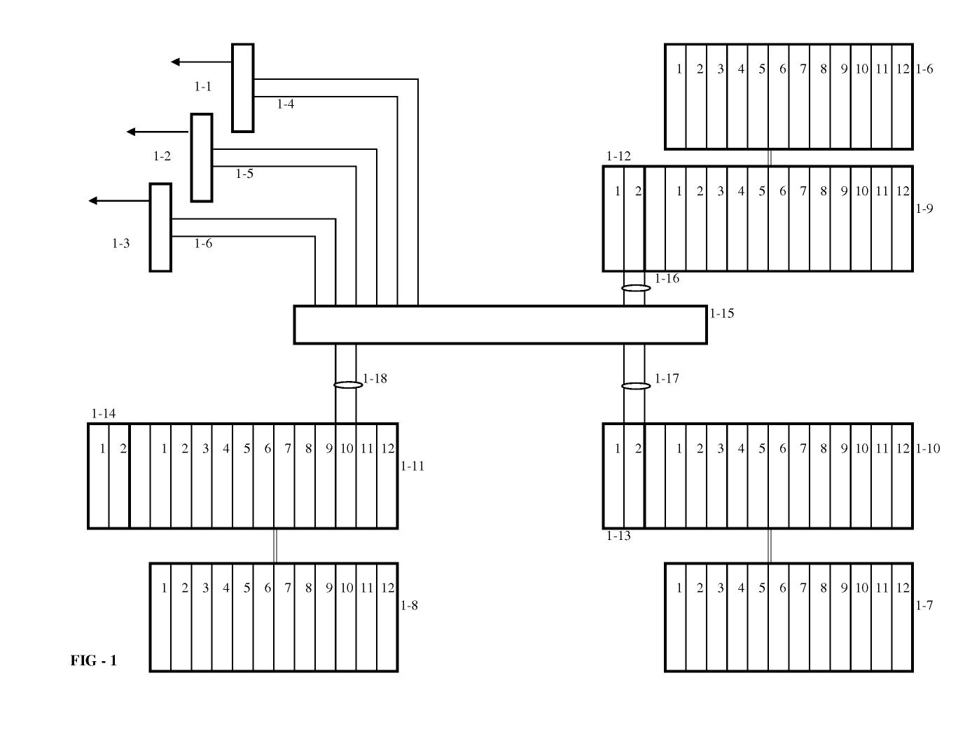

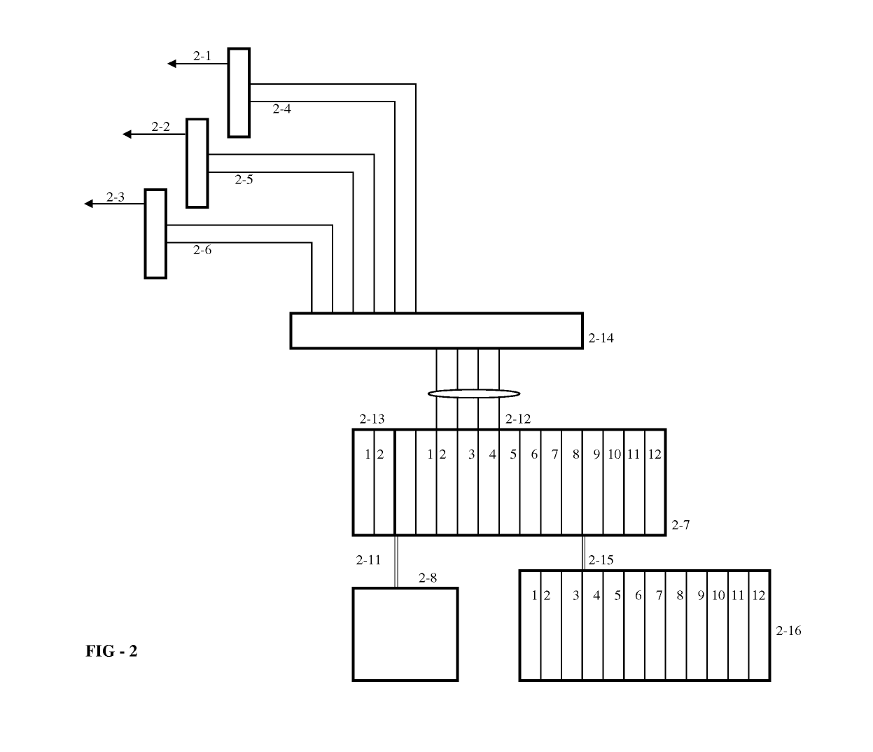

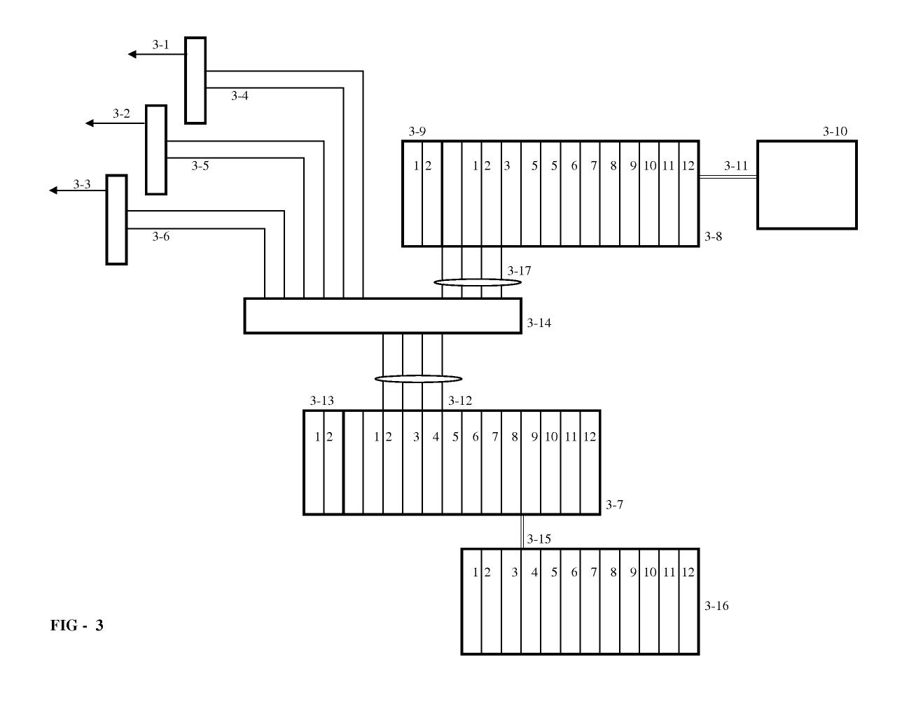

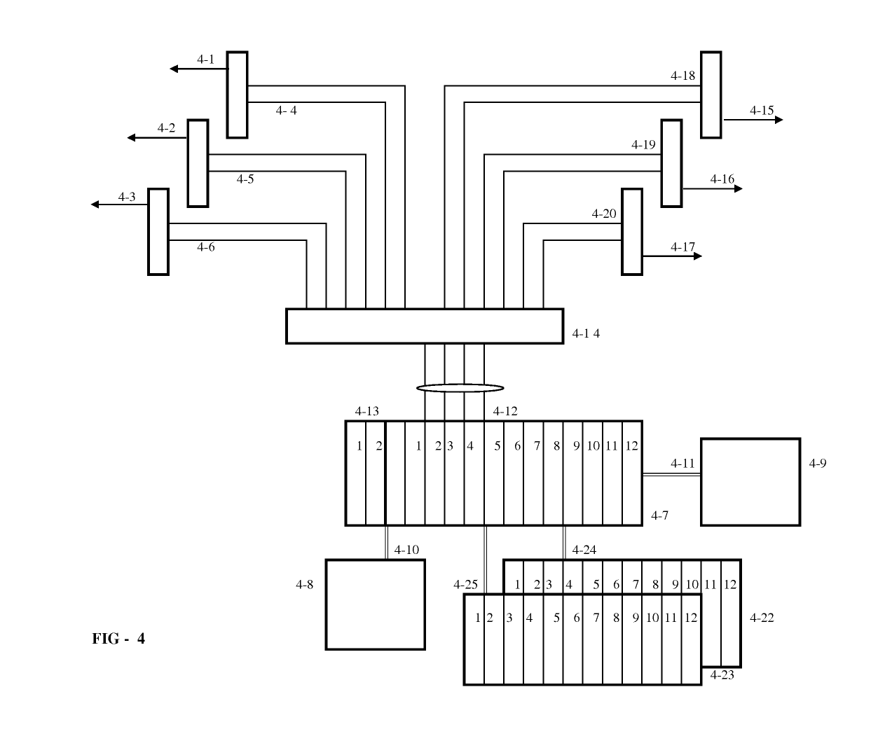

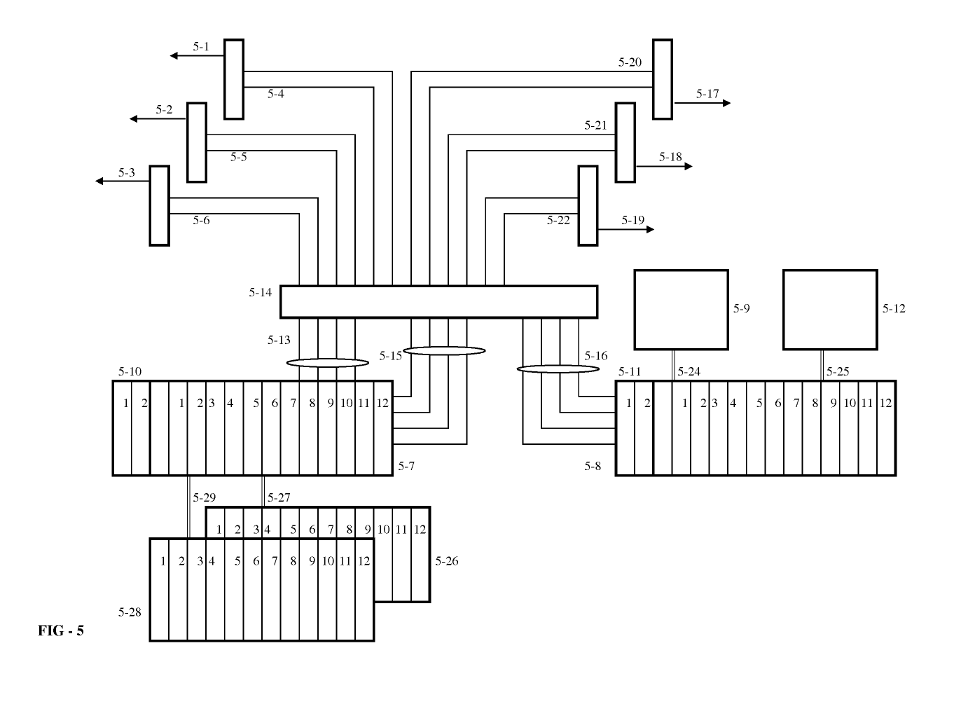

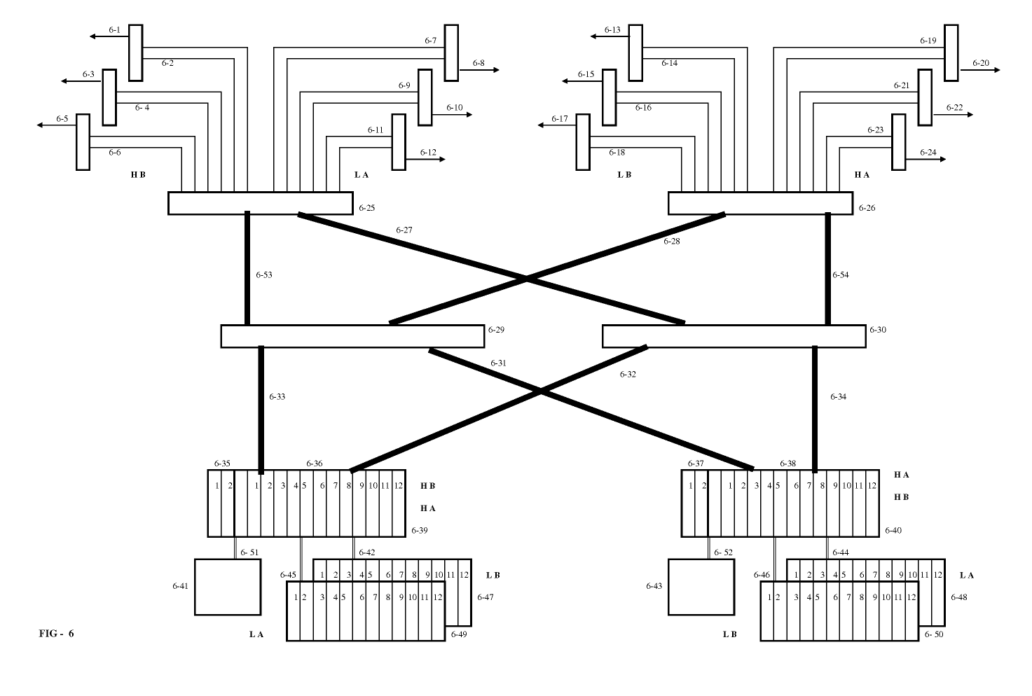

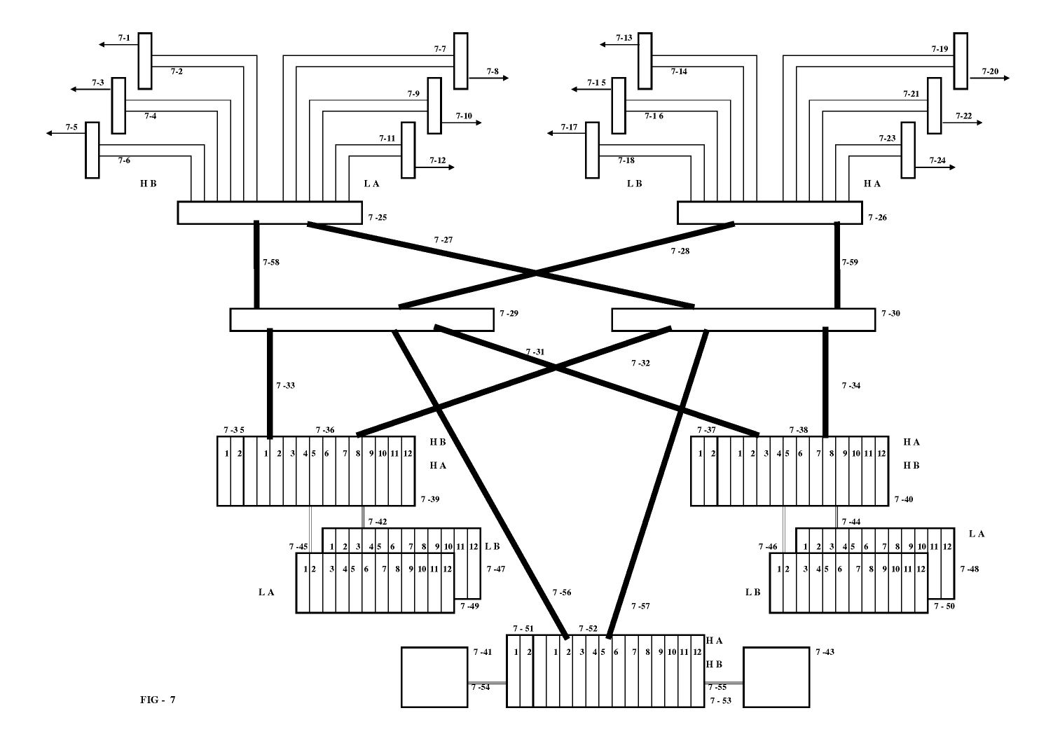

Illustrates the TSSS single tier high availability solution for collecting the data from (2×N pairs) number of CCTV camera pairs monitoring the same (FOV). The first set of CCTV cameras in the camera pairs are connected to edge switches (6-1,3,5,13,15,17) then through links (6-2,4,6) to the intermediate switch (6-25) and through links (6-14,16,18) to the intermediate switch (6-26) and the second set of CCTV cameras in the camera pairs are connected to edge switches (6-8,10,12,20,22,24) then through links (6-7,9,11) to the intermediate switch (6-25) and through links (6-19,21,23) to the intermediate switch (6-26). Intermediate switch (6-25) is connected through link (6-27) to core switch (6-30) and through link (6-53) to core switch (6-29). Intermediate switch (6-26) is connected through link (6-28) to core switch (6-29) and through link (6-54) to core switch (6-30). The core switch (6-29) is linked through redundant connections to two sets of VMS (NVR) servers (6-39,40), the core switch (6-30) is linked through redundant connections to the same sets of VMS (NVR) servers (6-39,40) then from VMS (NVR) servers (6-39,40) to two single tape drives (6-41,43).

The two letters markings (LA, LB) the L is pointing to the visual inspection level image quality streams, the (A, B) are pointing to two monitoring CCTV camera sets.

The two letters markings (HA, HB) the H is pointing to the forensic inspection level image quality streams, the (A, B) are pointing to two monitoring CCTV camera sets,

The generated (L and H) data streams from CCTV Camera sets (A and B) are cross passed to both VMS (NVR) servers (fig-6-39,40) that means that each VMS (NVR) server store all the four coming streams (LA, HA, LB, HB).

FIG. 7.

Illustrates the TSSS two tier high availability solution for collecting the data from (2×N pairs) number of CCTV camera pairs monitoring the same (FOV). The first set of CCTV cameras in the camera pairs are connected to edge switches (7-1,3,5,13,15,17) then through links (7-2,4,6) to the intermediate switch (7-25) and through links (7-14,16,18) to the intermediate switch (7-26) and the second set of CCTV cameras in the camera pairs are connected to edge switches(7-8,10,12,20,22,24) then through links (7-7,9,11) to the intermediate switch (7-25) and through links (7-19,21,23) to the intermediate switch (7-26). Intermediate switch (7-25) is connected through link (7-27) to core switch (7-30) and through link (7-58) to core switch (7-29). Intermediate switch (7-26) is connected through link (7-28) to core switch (7-29) and through link (7-59) to core switch (7-30).The core switch (7-29) is linked through redundant connections to two sets of VMS (NVR) servers (7-39,40). The core switch (7-30) is linked through redundant connections to the same sets of VMS (NVR) servers (7-39,40) then from VMS (NVR) servers (7-39,40) through links (7-31,32) to switches (7-29,30) then through links (7-56,57) to the NAS server (7-53) then from NAS server (7-53) to two single tape drives (7-41,43).

The two letters markings (LA, LB) the L is pointing to the visual inspection level image quality streams, the (A, B) are pointing to two monitoring CCTV camera sets.

The two letters markings (HA, HB) the H is pointing to the forensic inspection level image quality streams, the (A, B) are pointing to two monitoring CCTV camera sets.

The generated (L and H) data streams from CCTV Camera sets (A and B) are cross passed to both VMS (NVR) servers (fig-7-39,40) that means that each VMS (NVR) server store both visual inspection level image quality streams (LA, LB) and the NAS server (7-53) store both forensic inspection level image quality streams (HA, HB).

### DETAILED DESCRIPTION

To understand the TSSS (TIME-SPACE STORAGE SOLUTION) method, there will be a short description of the traditional storage method for the information coming from CCTV cameras, the required storage space depends on (number of cameras, image quality and retention period), the storage space required can be in hundreds of TBytes.

Fig-1 shows how the traditional storage architect built.

The digital video data streams flow through TP links to the edge switches (fig-1-1,2,3), then through TP links (fig-1-4,5,6) to core switch (fig-1-15) after that the digital video data streams should be divided between a number of VMS (NVR) servers (fig-1-9,10,11) with scaled up storage by adding hard disks enclosures (fig-1-6,7,8), because one storage sever is incapable of controlling a large number of hard disks besides a single server represents a single point of failure that stops the whole monitoring activity.

At the end of detailed description a comparison between the traditional storage method and TSSS storage method using calculated values obtained from well known CCTV companies using their storage calculators.

TSSS Method Description

The TSSS (TIME-SPACE STORAGE SOLUTION) store two generated streams of CCTV data information coming from CCTV cameras, these two different qualities of digital video data streams can be obtained by one of the following ways:
A multi stream CCTV camera that can capture two recordable and separately configurable video data streams of the same (FOV).
A duel lens duel sensors CCTV camera that can capture two recordable and separately configurable video data streams of the same (FOV).
CCTV camera pair that can capture two recordable and separately configurable video data streams of the same (FOV).

The quality of these two digital video images are described as follows:
The lower quality CCTV video images should give an accepted visual inspection level and the following given values can be used as a guide line (fps not less than 12, compression not higher than 30% in scale of (10%-90%) using H.264 compression and resolution not less than VGA or (640×480) pixels.
The higher quality CCTV video images should give an accepted forensic inspection level and the following given values can be used as a guide line (fps not less than 25, compression not higher than 10% in scale of 10%-90% H.264 compression and resolution level shall be not less than 1.3 Mpixels.

TSSS method net architect depends totally on the relation between these parameters:
Number of cameras or camera pairs.
The visual inspection level resolution and forensic inspection level resolution.
Number of (fps), level of compression, number of recording hours per day and monitored area activity.
The retention period in days.
The size of the magnetic-tape media that stores the forensic inspection level data size for one day.

The TSSS method of storing the CCTV data streams can be built in different ways of network architect according to the needs and costs.

The described ways are the following ones:
A single tier network architect for (N) number of CCTV cameras or camera pairs (fig-2).
Two tier network architect for (N) number of CCTV cameras or camera pairs (fig-3).
Extended single tier network architect for (2×N) number of CCTV cameras or camera pairs (fig-4).
Extended two tier network architect for (2×N) number of CCTV cameras or camera pairs (fig-5).
High availability extended single tier network architect for (2×N pairs) number of CCTV camera pairs (fig-6).
High reliability extended two tier network architect for (2×N pairs) number of CCTV camera pairs number of CCTV cameras or camera pairs (fig-7).

The type of storage arrangements and storage media needed in the TSSS method are as follows:
RAID (10,5,6) and SAS hard disks for storing forensic inspection level of the incoming data.
RAID (5,6) and SAS hard disks for storing visual inspection level of the incoming data.
One or two single LTO 6 tape drive with LTO 6 magnetic-tape media for best reliably and storage size.

The Detailed Description of a Single Tier Network Architect for (N) Number of CCTV Cameras or Camera Pairs (fig-2).

The visual inspection level and forensic inspection level data streams are generated by the CCTV cameras (multi stream, dual or camera pair), these streams will flow through twisted pair (TP) links to what is named edge switches (fig-2-1,2,3) then to what is named core switch (fig-2-14) through TP links (fig-2-4,5,6). The core switch is connected to what is named the VMS (NVR) server (fig-2-7) through trunk type of TP link (fig-2-12) to pass through the entire visual inspection level and forensic inspection level data streams coming from all the CCTV cameras.

The visual inspection level data stream entering the VMS (NVR) server (fig-2-7) will be directed to what is named (visual inspection data storage), this storage of hard disks arranged RAID (fig-2-16) is capable of storing the visual inspection level incoming data for the whole retention period. The forensic inspection level data stream entering the VMS (NVR) server (fig-2-7) will be directed to what is named (forensic inspection data storage), this storage of hard disks arranged RAID, which is located inside the VMS (NVR) server itself (fig-2-7) capable of storing the forensic inspection level incoming data for one day only and at the end of the day the backup software perform a full backup task to migrate the forensic inspection stored data from VMS (NVR) server (fig-2-7) to the magnetic-tape drive (fig-2-8) through the link (fig-2-11), this backup task is a scheduled full backup with data CRC check on daily basis and configured with the following job options:
The backup software shall be configured to (exclude all open files with no retries) in backup job option.
The backup software shall be configured to delete all and only the source files that has been backed up and keep all the source directories intact even the empty ones.
After the completion of backup the backup software will be configured to execute the command of ejecting the removable magnetic-tape media.

The VMS (NVR) server (fig-2-7) should include a RAID 0 set of hard disks with its storage capacity equal in size to what is named (forensic inspection data storage) and that storage is for restore purposes.

The Detailed Description of a Two Tier Network Architect for (N) Number of CCTV Cameras or Camera Pairs (fig-3).

The two tier method follows exactly the same steps as in single tier method and it differs only in the process of migrating the forensic inspection stored data.

The visual inspection level and forensic inspection level data streams are generated by the CCTV cameras (multi stream, dual or camera pair), these streams will flow through twisted pair (TP) links to what is named edge switches (fig-3-1,2,3) then through TP links (fig-3-4,5,6) to what is named core switch (fig-3-14). The core switch is connected to what is named the VMS (NVR) server (fig-3-7) through trunk type of TP link (fig-3-12) to pass through the entire visual inspection level and forensic inspection level data streams coming from all the CCTV cameras.

The visual inspection level data stream entering the VMS (NVR) server (fig-3-7) will be directed to what is named (visual inspection storage), this storage of hard disks arranged RAID (fig-3-16) is capable of storing the incoming visual inspection level data for the whole retention period. The forensic inspection level data stream entering the VMS (NVR) server (fig-3-7) will be directed to what is named (forensic inspection storage), this storage of hard disks arranged RAID, which is located inside the VMS (NVR) server itself (fig-3-7) capable of storing the incoming forensic inspection level data for one day only and at the end of the day the backup software perform a full copy task to migrate he forensic inspection stored data from VMS (NVR) server (fig-3-7) through trunk link (fig-3-12) to the core switch (3-14), then through trunk link (fig-3-17) to the NAS server (fig-3-9) with a storage capacity equal to what is named (forensic inspection storage).

The full copy task is a scheduled full copy with data CRC check on daily basis and configured with the following job options:
The backup software shall be configured to (exclude all open files with no retries) in the copy job option.
The backup software shall be configured to delete all and only the source files that has been copied up and keep all the source directories intact even the empty ones.

At the end of full copy task the backup software is configured to perform a full backup task to migrate the forensic inspection stored data from NAS server (fig-3-8) to the magnetic-tape drive (fig-3-10) through the link (fig-3-11), this backup task is a scheduled full backup with data CRC check on daily basis and configured with the following job options:
The backup software shall be configured to (exclude all open files with no retries) in backup or copy job option.
The backup software shall be configured to delete all and only the source files that has been backed up or copied and keep all the source directories intact even the empty ones.
After the completion of backup the backup software shall be configured to execute the command of ejecting the removable magnetic-tape media.

The NAS server (fig-3-8) should include a RAID 0 set of hard disks with its storage capacity equal in size to what is named (forensic inspection storage) and that storage is for restore purposes.

The Detailed Description of Extended Single Tier Network Architect for (2×N) Number of CCTV Cameras or Camera Pairs (fig-4).

The extended single tier method follows exactly the same process of single tier for (N) number of cameras data flow, but the data coming from the CCTV cameras is double in size and there shall be two sets of what is named visual inspection storage and two sets of what is named forensic inspection storage in the VMS (NVR) server (fig-4-7)

The hardware scaling up requirements to support the throughput of data coming from (2×N) number of CCTV cameras is as follows:
The VMS (NVR) server (fig-4-7) hardware should be upgraded to fulfill the new added load if needed.
A second enclosure that contain hard disks storage pool to store the visual inspection level data coming from the new set of cameras. The old and the added enclosures are (fig-4-22,23).
A second hard disks storage pool is added to the VMS (NVR) server (fig-4-7) to store the forensic inspection level data coming from the added set of cameras.
A second magnetic-tape drive to store the forensic inspection level migrated data coming from the VMS (NVR) server (fig-4-7) new (forensic inspection storage). The magnetic-tape drives are (fig-4-8,9).

The Detailed Description of Extended Two Tier Network Architect for (2×N) Number of CCTV Cameras or Camera Pairs (fig-5).

The extended single tier method follows exactly the same process of two tier for (N) number of cameras data flow, but the data coming from the CCTV cameras is double in size and there shall be two sets of what is named visual inspection storage and two sets of what is named forensic inspection storage in the VMS (NVR) server (fig-5-7). The NAS server (fig-5-8) shall contain two sets of what is named forensic inspection storage pools.

The hardware scaling up requirements to support the throughput of data coming from (2×N) number of CCTV cameras is as follows:
The VMS (NVR) server (fig-5-7) hardware should be upgraded to fulfill the new added load if needed.
The NAS server (fig-5-8) hardware should be upgraded to fulfill the new added load if needed.
A second enclosure of hard disks storage pool to store the visual inspection level data coming from the new set of cameras. The old and the added enclosures are (fig-5-26,28).
A second hard disks storage pool is added to the VMS (NVR) server (fig-5-7) to store the forensic inspection level data coming from the added set of cameras.
A second hard disks storage pool is added to the NAS server (fig-5-8) to store copies of forensic inspection data coming from VMS (NVR) server (fig-5-7).
A second magnetic-tape drive is added to store the forensic inspection level migrated data coming from the NAS server (fig-5-8). The magnetic-tape drives are (fig-5-9,12).

The following networks architect (fig-6,7) represents high availability solution. The highest availability solution is done by using camera pairs for the same (FOV) connected through separate TP links to different edge switches, the single link multi-stream cameras and dual lens dual sensor cameras are depending on VMS (NVR) servers that supports multi-stream reception. Switches that supports IP/TCP uni-cast and multi-cast configuration should be used in both cases.

The Detailed Description of High Availability Extended Single Tier Network Architect for (2×N Pairs) Number of Cameras (fig-6).

The high availability extended single tier network architect for (2×N pairs) number of CCTV cameras consist of two identical extended single tier network architect, with cross connection of CCTV camera pairs to provides a higher level of availability.

The high availability network architect is performed by arranging the cameras in two sets and each set consist of two levels of image quality in the same way as previous (single tier) methods, To explain the high availability architect a letter is appointed for the image quality and another letter is for defining CCTV cameras monitoring set, combining the two letters markings (LA, LB) points to visual inspection level image quality streams for the camera sets (A, B)

The two letters markings (HA, HB) pointing to forensic inspection level image quality streams for camera sets (A, B).

The generated (L and H) data streams from CCTV camera sets (A and B) are cross passed to both VMS (NVR) servers (fig-6-39,40) that means each VMS (NVR) server store the all four coming streams (LA, HA, LB, HB).

The hardware requirements for high availability network architect that supports the throughput of data coming from (2×N pairs) number of CCTV cameras is as follows:
Two intermediate switch (fig-6-25,26) that supports trunk link.
Two core switch (fig-6-29,30) that supports trunk link.
Two VMS (NVR) servers (fig-6-39,40), the hardware of each should supports the added throughput load coming from (2×N pairs) number of CCTV cameras if needed.
Each of VMS (NVR) servers (fig-6-39,40) has two enclosures, each contains hard disks storage pool to store what is named the visual inspection level data coming from each set of related CCTV cameras. The enclosures are (fig-6-47,48,49,50).
Each of VMS (NVR) servers (fig-6-39,40) contains two sets of storage pools that store what is named the forensic inspection level data coming from each set of related CCTV cameras.
Two magnetic-tape drive to store what is named the forensic inspection level migrated data coming from the VMS (NVR) server (fig-6-39) into magnetic-tape drives (fig-6-41,43).

This network architect shall preserve at least one what is named visual inspection level data of one camera set and one what is named forensic inspection level data of the other camera set, the sets can be one of the following:
CCTV camera set A sending what is named visual inspection level data and CCTV cameras set B sending what is named forensic inspection level data.
CCTV camera set B sending what is named visual inspection level data and CCTV cameras set A sending what is named forensic inspection level data.

This is true only if one of intermediate switch (6-25,6) stops functioning, otherwise all the incoming data are preserved, visual inspection level and forensic inspection level from both sets (LA, LB, HA, HB).

The Detailed Description of High Availability Extended Two Tier Network Architect for (2×N Pairs) Number of Camera Pairs (fig-7).

The high availability extended single tier network architect for (2×N pairs) number of CCTV cameras consist of two identical extended single tier network architect, with cross connection of CCTV camera pairs to provides a higher level of availability.

The high availability network architect is performed by arranging the cameras in two sets and each set consist of two levels of image quality in the same way as previous (single tier) methods, To explain the high availability architect a letter is appointed for the image quality and another letter is for defining CCTV cameras monitoring set, combining the two letters markings (LA, LB) points to visual inspection level image quality streams for the camera sets (A, B) The two letters markings (HA, HB) pointing to forensic inspection level image quality streams for camera sets (A, B).

The generated (L and H) data streams from CCTV Cameras sets (A and B) are cross passed to both VMS (NVR) servers (fig-7-39,40) that means that each VMS (NVR) server store the all four coming streams (LA, HA, LB, HB).

The hardware requirements for high availability network architect that supports the throughput of data coming from (2×N) number of CCTV cameras is as follows:
Two intermediate switch (fig-7-25,26) that supports trunk link.
Two core switch (fig-7-29,30) that supports trunk link.
Two VMS (NVR) servers (fig-7-39,40), the hardware of each should supports the added throughput load coming from (2×N pairs) number of CCTV cameras if needed.
Each of VMS (NVR) servers (fig-7-39,40) has two enclosures, each contains hard disks storage pool to store what is named the visual inspection level data coming from each set of cameras. The enclosures are (fig-7-47,48,49,50).
Each of VMS (NVR) servers (fig-7-39,40) contains two sets of storage pools that store what is named the forensic inspection level data coming from CCTV cameras.
Single NAS sever (fig-7-53)
Two magnetic-tape drive to store what is named the forensic inspection level migrated data coming from the NAS sever (fig-7-53) into magnetic-tape drives, these magnetic-tape drives are (fig-7-41,43).

This network architect shall preserve at least one what is named visual inspection level data of one camera set and one what is named forensic inspection level data of the other camera set, the sets can be one of the following:
CCTV cameras set A sending what is named visual inspection level data and CCTV cameras set B sending what is named forensic inspection level data.
CCTV cameras set B sending what is named visual inspection level data and CCTV cameras set A sending what is named forensic inspection level data.

This is true only if one of intermediate switch (7-25,6) stops functioning and NAS server is functioning, otherwise all the incoming data are preserved, visual inspection level and forensic inspection level from both sets (LA, LB, HA, HB). In case the NAS server (fig-7-53) stops functioning, then only this kind of data shall be preserved (CCTV cameras set A sending visual inspection level data and CCTV cameras set B sending visual inspection level data also). (there can be more alternatives of high availability network architect).

The Following Examples are Using Storage Space Calculation Tools from Three well known CCTV Companies to Generate the Required Storage Space.

(ExacqVision, Digifort) for 60 CCTV cameras and (Axis) for 50 CCTV Cameras

The calculation is done for the following parameters:
24 hours recording per day.
60 days of retention period
High activity area like train station
30 fps assuming or choosing CCTV cameras that supports that figure (30 fps)
Lowest possible compression to preserve pest quality.

The Size of Needed Storage According to (ExacqVision) Calculation (2 Mpixels Resolution)

| Compression | H. 264 level of compression | |
|---|---|---|
| | not given | |
| IP Cameras: | 60 | |
| Storage Data Rate: | 663.8 | Mbps |
| Storage Required: | 430168.32 | GB |

| | |
|---|---|
| Number of Servers | 6 servers |

The Size of Needed Storage According to (ExacqVision) Calculation (VGA Resolution)

| Compression | H. 264 level of compression | |
|---|---|---|
| | not given | |
| IP Cameras: | 60 | |
| Storage Data Rate: | 97.9 | Mbps |
| Storage Required: | 63452.16 | GB |
| total needed in case of recording | 493620.48 | GB |
| the two quality levels | | |

| | |
|---|---|
| Number of Servers | 7 servers |

TSSS Method Storage Space Needed

| | |
|---|---|
| One day storage | 7169.47 GB for forensic |
| | inspection level |

Covered by having 2 storage sets of 6 TB each (inside the server)

| | |
|---|---|
| Retention period Storage Required: | 63452.16 GB for visual inspection |
| | level for 60 days |

Covered by having 2 storage sets of 44 TB each (two outside enclosures)

| | |
|---|---|
| Number of Servers | 1 server |
| Number of Magnetic tape drive | 2 drives plus 62 LTO 6 tapes |

The Size of Needed Storage According to (Digifort) Calculation (1920×1080 Pixels Resolution)

| Compression | H. 264 high quality | |
|---|---|---|
| IP Cameras: | 60 | |
| Storage Data Rate: | 840.0 | Mbps |
| Storage Required: | 519.1 | TB |

| | |
|---|---|
| Number of Servers | 2 servers |

The Size of Needed Storage According to (Digifort) Calculation (VGA Resolution)

| Compression | H. 264 high quality | |
|---|---|---|
| IP Cameras: | 60 | |
| Storage Data Rate: | 112.5 | Mbps |
| Storage Required: | 69.5 | TB |
| Number of Servers | 1 servers | |
| total needed in case of | 588.6 | TB |
| recording the two quality levels | | |

| | |
|---|---|
| Number of Servers | 2 servers (the server in this case should |
| | be very powerful ones because the size |
| | of storage shall be around 300 TB each) |

TSSS Method Storage Space Needed

| | |
|---|---|
| One day storage | 8.7 TB for forensic inspection |
| | level |

Covered by having 2 storage sets of 6 TB each (inside the server)

| | |
|---|---|
| Retention period Storage Required | 69.5 TB for visual inspection |
| | level for 60 days |

Covered by having 2 storage sets of 44 TB each (two outside enclosures)

| | |
|---|---|
| Number of Servers | 1 server |
| Number of Magnetic tape drive | 2 drives plus 62 LTO 6 tapes |

The Size of Needed Storage According to (AXIS) Calculation (1920×1080 Pixels Resolution)

| Compression | H. 264 10% compression | |
|---|---|---|
| | highest quality | |
| IP Cameras: | 50 | |
| Storage Data Rate: | 726 | Mbps |
| Storage Required: | 470 | TB |

number of servers not given

The Size of Needed Storage According to (AXIS) Calculation (VGA Resolution)

| Compression | H. 264 10% compression | |
|---|---|---|
| | highest quality | |
| IP Cameras: | 50 | |
| Storage Data Rate: | 107 | Mbps |
| Storage Required: | 69.7 | TB |
| Servers needed is not included in | | |
| AXIS tools | | |
| total needed in case of recording | 539.7 | TB |
| the two quality levels | | |

TSSS Method Storage Space Needed

| | | |
|---|---|---|
| One day storage | 7.84 | TB for forensic inspection |
| | | level |

Covered by having 2 storage sets of 6 TB each (inside the server)

| | | |
|---|---|---|
| Retention period Storage Required | 69.7 | TB for visual inspection |
| | | level for 60 days |

Covered by having 2 storage sets of 44 TB each (two outside enclosures)

| | |
|---|---|
| Number of Servers | 1 server |
| Number of Magnetic tape drive | 2 drives plus 62 LTO 6 tapes. |

The calculated (TSSS method) storage values in these examples are referenced on choosing LTO 6 as magnetic-tape media, changing the size of the magnetic-tape media will effect all other parameters (number of cameras or camera pairs, resolution, fps, retention period, HD storage sizes) in the TSSS method.

1. I claim that the TSSS method provides two recorded copies of the CCTV cameras data information, the first recorded copy is useable for visual inspection preserving most of the needed information, the second recorded copy is useable for forensic inspection utilizing the highest level of image quality that can be submitted by the used CCTV cameras for the whole retention period.

2. In TSSS method I claim that the size of storage in VMS (NVR) server is calculated to store the CCTV cameras forensic inspection data information for one day only. At the end of each day a backup software is configured to migrate the VMS (NVR) server stored information coming from CCTV cameras to a magnetic-tape (single tier architect) or NAS server storage then to a magnetic-tape (two tier architect). The backup software should be configured also to execute the following job options (no backup or copy of open files, no retry, source file deletion and magnetic-tape eject when finishing backup task).

3. I claim that the TSSS method provides high level of availability for the whole retention period by having two recorded copies of the CCTV cameras data information and selective off-line copies for unlimited period of time.
